(19) United States
(12) Patent Application Publication
(10) Pub. No.: US 2024/0359127 A1
(43) Pub. Date: Oct. 31, 2024

(54) METHOD FOR PRODUCING PURIFIED GAS, METHOD FOR PRODUCING DRY ICE, APPARATUS FOR PRODUCING PURIFIED GAS, AND EQUIPMENT FOR PRODUCING DRY ICE

(71) Applicant: AIR WATER INC., Osaka (JP)

(72) Inventors: Nanako NISHII, Osaka (JP); Masayuki KANEKO, Osaka (JP); Megumi YAMANO, Osaka (JP); Leona GOHDA, Osaka (JP); Takanori KAIGAWA, Osaka (JP)

(21) Appl. No.: 18/689,672

(22) PCT Filed: Aug. 22, 2022
(86) PCT No.: PCT/JP2022/031509

§ 371 Date: Mar. 6, 2024

(30) Foreign Application Priority Data
Sep. 7, 2021 (JP) 2021-145077

(51) Int. Cl. B01D 53/04; B01D 53/14; C01B 32/55

(52) U.S. Cl. CPC B01D 53/04; B01D 53/1475; C01B 32/55; B01D 2253/102

(57) ABSTRACT

A method for producing a purified gas containing carbon dioxide gas, comprising: a first concentration step in which an intermediate gas having a higher concentration of carbon dioxide gas than a target gas is produced by vacuum regeneration pressure swing adsorption using a first adsorption tower that adsorbs carbon dioxide gas from the target gas containing carbon dioxide gas; and a second concentration step in which the purified gas having an even higher concentration of carbon dioxide gas than the intermediate gas is produced by vacuum regeneration pressure swing adsorption using a second adsorption tower that adsorbs carbon dioxide gas from the intermediate gas or membrane separation.

### TECHNICAL FIELD

The present disclosure relates to a method for producing a purified gas, a method for producing dry ice, an apparatus for producing a purified gas, and equipment for producing dry ice.

### BACKGROUND ART

In recent years, methods for recovering and reusing carbon dioxide gas (CO₂) in exhaust gas discharged from factories and the like have been studied to reduce global greenhouse gas. Among them, dry ice is a coolant that is easy to handle and is widely used also in various fields other than food refrigerated transport. On the other hand, recovered carbon dioxide gas can effectively be used by, for example, concentration to a high concentration of 90 vol % or more.

For example, PTL 1 (Japanese Patent Laying-Open No. 5-116927) and PTL 2 (Japanese Patent Laying-Open No. 2010-208891) disclose that carbon dioxide gas is directly turned into dry ice by removing moisture in exhaust gas and then cooling the exhaust gas to a solidification temperature. Further, PTL 3 (Japanese Patent Laying-Open No. 2011-250759) discloses that carbon dioxide gas is concentrated by adsorption or membrane separation and then turned into dry ice by cooling to a solidification temperature, and PTL 4 (Japanese Patent Laying-Open No. 2004-085099) discloses that carbon dioxide gas is concentrated by thermal-pressure swing adsorption and then turned into dry ice by liquefaction.

### CITATION LIST

### Patent Literature

PTL 1: Japanese Patent Laying-Open No. 5-116927
PTL 2: Japanese Patent Laying-Open No. 2010-208891
PTL 3: Japanese Patent Laying-Open No. 2011-250759
PTL 4: Japanese Patent Laying-Open No. 2004-085099

### SUMMARY OF INVENTION

### Technical Problem

In PTLs 1 to 3, carbon dioxide gas is directly turned into dry ice by cooling to a solidification temperature. However, when a low concentration of carbon dioxide gas is directly solidified, a large amount of exhaust gas is required as a raw material relative to the amount of carbon dioxide gas that can be recovered, and therefore large facilities are required. Further, energy efficiency is not high because only a small amount of dry ice can be produced from a large amount of exhaust gas.

In PTL 4, carbon dioxide gas is concentrated by thermal-pressure swing adsorption that is a combination of thermal swing adsorption and pressure swing adsorption. Thermal swing adsorption requires the step of regeneration by heating and the step of cooling, and therefore it takes time to exchange heat and the cycle of switching an adsorption tower becomes longer. Therefore, the amount of gas treated per tower increases so that the adsorption tower is larger than that for pressure swing adsorption. Further, a heat source is required for heating, and therefore it is necessary to provide a device for supplying heat, such as an electric heater, which increases energy required for the heat source. On the other hand, pressure swing adsorption requires a purge step in which product carbon dioxide gas is flowed into an adsorption tower filled with an adsorbent before recovery of carbon dioxide gas to remove impurities present in voids in the adsorption tower. This purge step requires a blower for purge gas, and therefore large facilities are required Further, energy efficiency is not high because electric power for facilities is increased by installation of the blower.

It is an object of the present disclosure to provide a method for producing a purified gas which is capable of extracting a purified gas containing a high concentration of carbon dioxide gas while reducing energy consumption, an apparatus for producing a purified gas, a method for producing dry ice from a purified gas, and equipment for producing dry ice.

### Solution to Problem

[1] A method for producing a purified gas containing carbon dioxide gas, comprising:
a first concentration step in which an intermediate gas having a higher concentration of carbon dioxide gas than a target gas is produced by vacuum regeneration pressure swing adsorption using a first adsorption tower that adsorbs carbon dioxide gas from the target gas containing carbon dioxide gas; and
a second concentration step in which the purified gas having an even higher concentration of carbon dioxide gas than the intermediate gas is produced by vacuum regeneration pressure swing adsorption using a second adsorption tower that adsorbs carbon dioxide gas from the intermediate gas or membrane separation.

[2] The method for producing a purified gas according to [1], wherein the target gas has a carbon dioxide gas concentration of 3 vol % or more and 70 vol % or less.

[3] The method for producing a purified gas according to [1] or [2], wherein the intermediate gas has a carbon dioxide gas concentration of 50 vol % or more and 80 vol % or less.

[4] The method for producing a purified gas according to any one of [1] to [3], wherein the purified gas has a carbon dioxide gas concentration of 95 vol % or more.

[5] The method for producing a purified gas according to any one of [1] to [4], wherein the first concentration step and the second concentration step do not have a purge step to discharge impurities in the first adsorption tower and the second adsorption tower.

[6] The method for producing a purified gas according to any one of [1] to [5], wherein two or more of the first adsorption towers and two or more of the second adsorption towers are used.

[7] The method for producing a purified gas according to any one of [1] to [6], wherein in the second concentration step, carbon dioxide gas is concentrated at a higher pressure than in the first concentration step.

[8] A method for producing dry ice, including:
obtaining a purified gas by the method for producing a purified gas according to any one of [1] to [7];
a liquefying step in which the purified gas is cooled to produce liquefied carbon dioxide; and
a dry ice production step in which the liquefied carbon dioxide is solidified to obtain dry ice.

[9] The method for producing dry ice according to [8], including a dehumidifying step to remove moisture in the purified gas prior to the liquefying step.

[10] The method for producing dry ice according to [8] or [9], wherein the dry ice production step includes a forming step to form dry ice.

[11] An apparatus for producing a purified gas containing carbon dioxide gas, comprising:
a first concentration device that produces an intermediate gas having a higher concentration of carbon dioxide gas than a target gas, wherein the first concentration device includes a first adsorption tower that adsorbs carbon dioxide gas in the target gas containing carbon dioxide gas by vacuum regeneration pressure swing adsorption; and
a second concentration device that produces a purified gas having an even higher concentration of carbon dioxide gas than the intermediate gas, wherein the second concentration device includes a second adsorption tower that adsorbs carbon dioxide gas in the intermediate gas by vacuum regeneration pressure swing adsorption or a membrane separation device that selectively passes carbon dioxide gas in the intermediate gas.

[12] The apparatus for producing a purified gas according to [11], including two or more of the first adsorption towers and two or more of the second adsorption towers.

[13] Equipment for producing dry ice, including:
the apparatus for producing a purified gas according to [11] or [12];
a refrigerating machine that cools the purified gas to produce liquefied carbon dioxide; and
a dry ice production apparatus that solidifies the liquefied carbon dioxide to produce dry ice.

[14] The equipment for producing dry ice according to [13], further including a dehumidifying part that removes moisture before liquefied carbon dioxide is produced.

[15] The equipment for producing dry ice according to [13] or [14], wherein the dry ice production apparatus includes a forming device that forms dry ice.

### Advantageous Effects of Invention

According to the present disclosure, it is possible to provide a method for producing a purified gas which is capable of extracting a purified gas containing a high concentration of carbon dioxide gas while reducing energy consumption, an apparatus for producing a purified gas, a method for producing dry ice from a purified gas, and equipment for producing dry ice.

### BRIEF DESCRIPTION OF DRAWINGS

FIG. 1 is a schematic flow diagram of a method for producing a purified gas according to an embodiment of the present disclosure.

FIG. 2 is a schematic flow diagram of a method for producing dry ice according to an embodiment of the present disclosure.

FIG. 3 is a schematic diagram showing an example of configuration of an apparatus for producing a purified gas according to an embodiment of the present disclosure.

### DESCRIPTION OF EMBODIMENTS

Hereinbelow, embodiments of the present disclosure will be described. However, the following description does not limit the claims.

### <Method for Producing Purified Gas>

A method for producing a purified gas according to the present disclosure includes:
a first concentration step in which an intermediate gas having a higher concentration of carbon dioxide gas than a target gas is produced by vacuum regeneration pressure swing adsorption using a first adsorption tower that adsorbs carbon dioxide gas from the target gas containing carbon dioxide gas, and
a second concentration step in which the purified gas having an even higher concentration of carbon dioxide gas than the intermediate gas is produced by vacuum regeneration pressure swing adsorption using a second adsorption tower that adsorbs carbon dioxide gas from the intermediate gas or membrane separation.

FIG. 1 is a schematic flow diagram of a method for producing a purified gas according to an embodiment of the present disclosure. Hereinbelow, each of steps of the method for producing a purified gas will be described. It should be noted that the method for producing a purified gas according to the present disclosure is described with reference to a case where a purified gas is produced through two steps: a first concentration step and a second concentration step, but the number of steps is not limited to two and a concentration step may further be included

### (First Concentration Step)

The first concentration step is a step in which an intermediate gas having a higher concentration of carbon dioxide gas than a target gas is produced by vacuum regeneration pressure swing adsorption using a first adsorption tower that adsorbs carbon dioxide gas from the target gas containing carbon dioxide gas. This step includes (1) an adsorption step, (2) a vacuum evacuation step, and (3) a pressure-restoring step.

The “target gas” herein means a gas containing at least carbon dioxide gas. The concentration of carbon dioxide gas in the target gas is preferably 3 vol % or more and 70 vol % or less, more preferably 5 vol % or more and 50 vol % or less, even more preferably 10 vol % or more and 50 vol % or less. The target gas may contain another gas as long as carbon dioxide gas is contained. The target gas may be, for example, exhaust gas from a factory or a farm. For example, the target gas is taken in from outside and introduced into the first adsorption tower. It should be noted that when exhaust gas is used as the target gas, harmful substances contained in the exhaust gas, such as nitrogen oxide (NOx) and sulfur oxide (SOx), are preferably removed by appropriate treatment.

The “intermediate gas” herein means a gas having a higher concentration of carbon dioxide gas than the target gas. The concentration of carbon dioxide gas in the target gas is preferably 50 vol % or more and 80 vol % or less, more preferably 60 vol % or more and 80 vol % or less. The intermediate gas may contain another gas as long as carbon dioxide gas is contained,

### (1) Adsorption Step

This step is a step in which the target gas is introduced into the first adsorption tower to adsorb carbon dioxide gas. The first adsorption tower is filled with an adsorbent to recover carbon dioxide gas contained in the target gas. Examples of the adsorbent include silica gel, activated alumina, activated carbon, zeolite, metal organic framework (MOF), and solid amine. In the first adsorption tower, moisture contained in the target gas may be adsorbed. The first adsorption tower may be filled with a combination of two or more adsorbents.

In this step, two or more first adsorption towers are preferably used. By using two or more first adsorption towers, the adsorption step is continuously performed. It should be noted that although the adsorption step is not continuously performed, this step can also be performed using only one first adsorption tower.

This step may be performed under a pressure of, for example, 5 kPaG or more and less than 0.1 MPaG.

### (2) Vacuum Evacuation Step

This step is a step in which the pressure of a gas after the adsorption step is reduced by a vacuum pump to recover an intermediate gas. In this step, the pressure is reduced to negative pressure and may be reduced to, for example, a low vacuum pressure of more than −60 kPaG. By reducing the pressure in such a way, an intermediate gas can efficiently be recovered.

### (3) Pressure-Restoring Step

This step is a step in which the pressure in the first adsorption tower after the vacuum evacuation step is restored. This step is performed by, for example, introducing a gas at atmospheric pressure. The gas at atmospheric pressure may be, for example, the target gas or exhausted gas discharged from the first adsorption tower after removing carbon dioxide gas in the adsorption step

### (4) Others

It is preferred that the first concentration step does not include a purge step to discharge a component other than carbon dioxide gas in the first adsorption tower. The “purge step” herein is a step in which carbon dioxide gas is flowed into the first adsorption tower between the adsorption step and the vacuum evacuation step to remove a component other than carbon dioxide gas (e.g., nitrogen gas) present in voids in the first adsorption tower. When the first concentration step includes the purge step, the first adsorption tower requires a blower for carbon dioxide gas, which increases the size of facilities and energy consumption. Even when the purge step is not performed, carbon dioxide gas is further concentrated in the second concentration step that will be described later, and therefore energy consumption can be reduced by not performing the purge step.

### (Second Concentration Step)

The second concentration step is a step in which a purified gas having an even higher concentration of carbon dioxide gas than an intermediate gas containing carbon dioxide gas is produced by vacuum regeneration pressure swing adsorption using a second adsorption tower that adsorbs carbon dioxide gas from the intermediate gas or membrane separation. When a purified gas is produced using an adsorbent, this step includes (1) an adsorption step, (2) a pressure equalization step, (3) an atmospheric evacuation step, (4) a vacuum evacuation step, and (5) a pressure-restoring step. When a purified gas is produced by membrane separation, this step includes a separation step.

The “purified gas” herein means a gas having a higher concentration of carbon dioxide gas than the intermediate gas. The concentration of carbon dioxide gas in the target gas is preferably 95 vol % or more, more preferably 98 vol % or more. The purified gas may contain another gas as long as carbon dioxide gas is contained.

### (1) Method Using Adsorbent

### (i) Adsorption Step

This step is a step to adsorb carbon dioxide gas contained in the intermediate gas. The second adsorption tower is filled with an adsorbent to recover carbon dioxide gas contained in the intermediate gas. Examples of the adsorbent include silica gel, activated alumina, activated carbon, zeolite, MOF, and solid amine. The second adsorption tower may be filled with a combination of two or more adsorbents.

In this step, two or more second adsorption towers are preferably used, and three or more second adsorption towers are more preferably used. By using two or more second adsorption towers, the adsorption step is continuously performed. It should be noted that although the adsorption step is not continuously performed, this step may also be performed by using only one second adsorption tower.

In this step, the intermediate gas needs to be compressed and is preferably compressed to 0.1 MPaG or more. When the intermediate gas is not compressed, the amount of carbon dioxide gas adsorbed to the second adsorption tower is reduced. This step is preferably performed at a higher pressure than the adsorption step in the first concentration step.

### (ii) Pressure Equalization Step

This step is a step in which a gas is transferred between the second adsorption tower after the adsorption step and the other second adsorption tower to equalize the pressure. The second adsorption tower just after the end of the adsorption step is in a pressurized state, and therefore a gas is transferred between the second adsorption tower just after the end of the adsorption step and the other second adsorption tower in a depressurized state just after the end of a recovery step to equalize the pressure between the both.

(iii) Atmospheric Evacuation Step

This step is a step in which a gas is discharged from the second adsorption tower that has been subjected to the pressure equalization step to reduce the pressure in the second adsorption tower to atmospheric pressure. It should be noted that the discharged gas may be introduced again into the second adsorption tower without being discharged to the atmosphere.

### (iv) Vacuum Evacuation Step

This step is a step in which the pressure of a gas after the atmospheric evacuation step is reduced by a vacuum pump to recover a purified gas. In this step, the pressure is reduced to negative pressure and may be reduced to, for example, a high vacuum pressure of more than −60 kPaG. By reducing the pressure in such a way, a purified gas can efficiently be recovered.

### (v) Pressure-Restoring Step

This step is a step to restore the pressure in the second adsorption tower after the vacuum evacuation step. This step is performed by, for example, introducing a gas at atmospheric pressure. The gas at atmospheric pressure may be, for example, exhausted gas discharged from the second adsorption tower after removing carbon dioxide gas in the adsorption step.

### (vi) Others

When the second concentration step is performed by adsorption, as in the case of the first concentration step, it is preferred that the second concentration step does not include a purge step to discharge a component other than carbon dioxide gas in the first adsorption tower. It should be noted that the purge step is the same as that described above with reference to the first concentration step, and therefore the description thereof will not be repeated.

### (2) Method by Membrane Separation

This method includes a separation step in which the intermediate gas is introduced into a separation membrane that selectively passes carbon dioxide gas to separate carbon dioxide gas. In this step, the intermediate gas is compressed and then introduced into the separation membrane, and therefore the difference in partial pressure across the membrane drives separation. In this step, the intermediate gas is preferably compressed to 0.2 MPaG or more.

In the present disclosure, the second concentration step is preferably performed by the method using an adsorbent from the viewpoint of energy consumption.

### <Method for Producing Dry Ice>

A method for producing dry ice according to the present disclosure includes:
obtaining a purified gas by the above-described method;
a liquefying step in which the purified gas is cooled to produce liquefied carbon dioxide; and
a dry ice production step in which the liquefied carbon dioxide is solidified to obtain dry ice.

The method preferably includes, between the obtaining a purified gas and the liquefying step, a dehumidifying step to remove moisture in the purified gas. Further, the dry ice production step preferably includes a forming step to form produced dry ice.

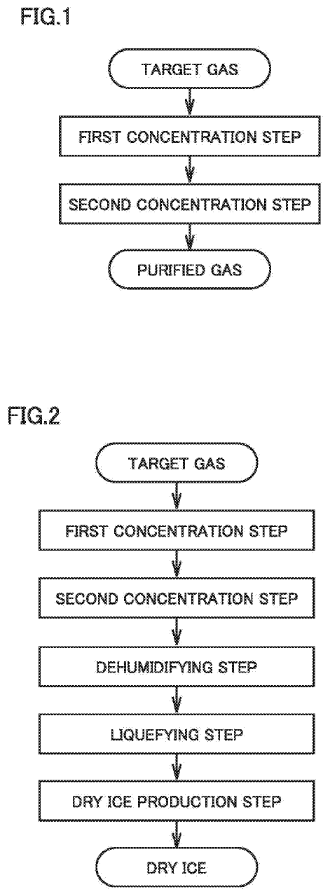

FIG. 2 is a schematic flow diagram of a method for producing dry ice according to an embodiment of the present disclosure Hereinbelow, each of steps of the method for producing dry ice will be described. It should be noted that the obtaining a purified gas is the same as that described above in <Method for producing purified gas>, and therefore the description thereof will not be repeated.

### (1) Dehumidifying Step

This step is a step to remove moisture in the purified gas. A dehumidifying method is not limited, and examples thereof include a method using an adsorption vessel filled with a dehumidifying agent and a method using a dehumidifying membrane. The dehumidifying membrane may be a polymeric membrane.

### (2) Liquefying Step

This step is a step in which the purified gas is cooled to produce liquefied carbon dioxide. A cooling method is preferably performed at a temperature of −20° C. or less and a pressure of 2.1 MPaG or more. This is because a general-purpose refrigerating machine can cool an object to be cooled to about −20° C., and turning carbon dioxide gas into liquefied carbon dioxide at −20° C. requires a pressure of 2.1 MPaG or more

### (3) Dry Ice Production Step

This step is a step in which the liquefied carbon dioxide is solidified to obtain dry ice. By reducing the pressure of the liquefied carbon dioxide produced under the above conditions to atmospheric pressure to solidify the liquefied carbon dioxide, dry ice can be obtained.

A method for forming dry ice is not limited, but dry ice can be produced by, for example, introducing carbon dioxide gas into a dry ice producing machine, reducing the pressure of carbon dioxide gas in the dry ice producing machine to solidify carbon dioxide gas, and compressing solidified dry ice. The dry ice can be formed into various shapes such as a block, a pellet, and a powder depending on the type of dry ice producing machine.

### <Apparatus for Producing Purified Gas>

An apparatus for producing a purified gas according to the present disclosure includes:
a first concentration device that produces an intermediate gas having a higher concentration of carbon dioxide gas than a target gas, the first concentration device including a first adsorption tower that adsorbs carbon dioxide gas in the target gas containing carbon dioxide gas by vacuum regeneration pressure swing adsorption, and
a second concentration device that produces a purified gas having an even higher concentration of carbon dioxide gas than the intermediate gas, the second concentration device including a second adsorption tower that adsorbs carbon dioxide gas in the intermediate gas by vacuum regeneration pressure swing adsorption or a membrane separation device that selectively passes carbon dioxide gas in the intermediate gas.

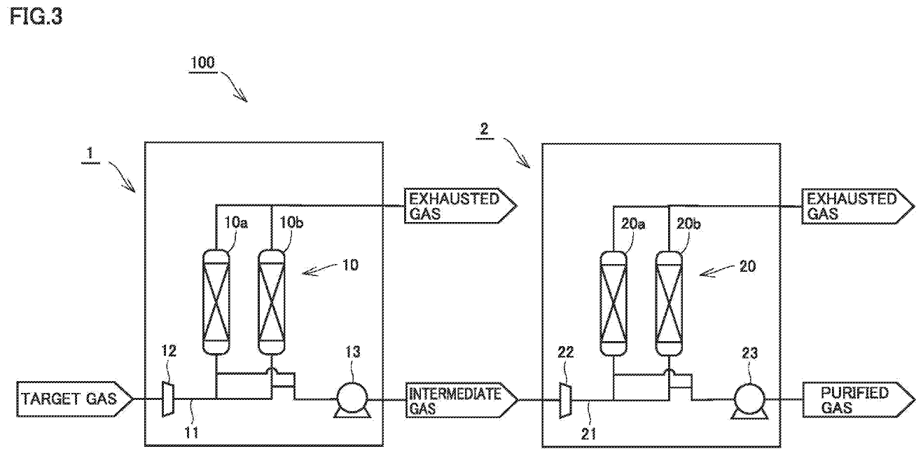

FIG. 3 is a schematic diagram showing an example of configuration of an apparatus for producing a purified gas according to an embodiment of the present disclosure. Hereinbelow, the apparatus for producing a purified gas will be described. It should be noted that a description overlapping with the above description in <Method for producing purified gas> will not be repeated. Further, the apparatus for producing a purified gas according to the present disclosure is described with reference to a case where the apparatus has a two-stage configuration including a first concentration device and a second concentration device, but the configuration of the apparatus is not limited to a two-stage configuration, and a concentration device may further be included

### (First Concentration Device)

A first concentration device 1 is a device that produces an intermediate gas having a higher concentration of carbon dioxide gas than a target gas by vacuum regeneration pressure swing adsorption using a first adsorption tower 10 that adsorbs carbon dioxide gas from the target gas containing carbon dioxide gas. That is, first concentration device 1 is a vacuum regeneration pressure swing adsorption device.

First adsorption tower 10 is filled with an adsorbent to recover carbon dioxide gas contained in the target gas. The target gas is led into first adsorption tower 10 by a first blower 12 through a target gas conduit pipe 11, and carbon dioxide gas contained in the target gas is adsorbed to the adsorbent. Then, the pressure of the adsorbed gas is reduced by a first vacuum pump 13 to obtain an intermediate gas. It should be noted that a gas not adsorbed to the adsorbent is discharged as exhausted gas.

As described above, first concentration device 1 preferably includes two or more first adsorption towers 10. In FIG. 3, first concentration device 1 is constituted from two first adsorption towers (a first adsorption tower 10a and a first adsorption tower 10b), and therefore an intermediate gas can continuously be produced by leading the target gas into first adsorption tower 10a and first adsorption tower 10b alternately.

### (Second Concentration Device)

A second concentration device 2 is a device that produces a purified gas having an even higher concentration of carbon dioxide gas than an intermediate gas and that includes a second adsorption tower 20 that adsorbs carbon dioxide gas in the intermediate gas by vacuum regeneration pressure swing adsorption or a membrane separation device that selectively passes carbon dioxide gas in the intermediate gas. In FIG. 3, second concentration device 2 is a vacuum regeneration pressure swing adsorption device.

### (1) Vacuum Regeneration Pressure Swing Adsorption Device

Second adsorption tower 20 is filled with an adsorbent to recover carbon dioxide gas contained in the intermediate gas. The intermediate gas is led into second adsorption tower 20 by a second blower 22 through an intermediate gas conduit pipe 21, and carbon dioxide gas contained in the intermediate gas is adsorbed to the adsorbent. Then, the pressure of the adsorbed gas is reduced by a second vacuum pump 23 to obtain a purified gas. It should be noted that a gas not adsorbed to the adsorbent is discharged as exhausted gas or joined with the intermediate gas and again introduced into second adsorption tower 20.

As described above, second concentration device 2 preferably includes two or more second adsorption towers 20 in FIG. 3, second concentration device 2 is constituted from two second adsorption towers (a second adsorption tower 20a and a second adsorption tower 20b), and therefore an intermediate gas can continuously be produced by leading the intermediate gas into second adsorption tower 20a and second adsorption tower 20b alternately.

### (2) Membrane Separation Device

The membrane separation device (not shown) includes a separation membrane module to allow carbon dioxide gas contained in the intermediate gas to selectively pass through. The intermediate gas is led into the separation membrane module by an intermediate gas compression machine so that carbon dioxide gas contained in the intermediate gas is separated by a separation membrane to obtain a purified gas.

### <Equipment for Producing Dry Ice>

Equipment for producing dry ice according to the present disclosure includes:
the above-described apparatus for producing a purified gas;
a refrigerating machine that cools the purified gas to produce liquefied carbon dioxide; and
a dry ice production apparatus that solidifies the liquefied carbon dioxide to produce dry ice.

The equipment for producing dry ice preferably includes a dehumidifying part that removes moisture after producing a purified gas and before producing liquefied carbon dioxide. Further, the dry ice production apparatus preferably includes a forming device that forms produced dry ice.

Hereinbelow, the equipment for producing dry ice will be described. It should be noted that the apparatus for producing a purified gas is the same as that described above in <Apparatus for producing purified gas>, and therefore a description thereof will not be repeated.

### (1) Dehumidifying Part

The dehumidifying part removes moisture in the purified gas. The dehumidifying part is not limited, and for example, an adsorption vessel filled with a dehumidifying agent or a dehumidifying membrane is provided.

### (2) Refrigerating Machine

The refrigerating machine cools the purified gas to produce liquefied carbon dioxide. The pressure of the purified gas is increased to 2.1 MPaG or more by a compression machine, and then the purified gas is cooled by the refrigerating machine to a temperature of −20° C. or less. The refrigerating machine is not limited as long as the purified gas can be cooled to −20° C. or less

### (3) Dry Ice Production Apparatus

The dry ice production apparatus solidifies the liquefied carbon dioxide to produce dry ice. The dry ice production apparatus is not limited as long as the liquefied carbon dioxide can be solidified.

The dry ice production apparatus is preferably one that can perform operations from solidification of liquefied carbon dioxide (production of dry ice) to forming of dry ice by itself. Examples of such a dry ice production apparatus include a block dry ice producing machine, a pellet dry ice producing machine, and a powder dry ice producing machine.

### EXAMPLES

Hereinbelow, Examples will be described. However, the following examples are not intended to limit the claims.

### Example 1

An apparatus for producing a purified gas was prepared which had vacuum regeneration pressure swing adsorption devices as a first concentration device and a second concentration device. A target gas having a carbon dioxide gas concentration of 10 vol % was prepared. A purified gas was produced in accordance with the above-described method for producing a purified gas. The conditions of the first concentration device and the second concentration device are as follows. The first concentration device used zeolite as a carbon dioxide gas adsorbent and activated alumina as a moisture adsorbent, and the second concentration device used activated alumina as a carbon dioxide gas adsorbent. It should be noted that a purge step was not performed.

### (Conditions of First Concentration Device)

Flow rate of target gas: 1000 NL/min
Adsorption pressure: 10 kPaG
Regeneration pressure: −90 kPaG
Temperature: 40° C.

### (Conditions of Second Concentration Device)

Flow rate of intermediate gas: 60 NL/min
Adsorption pressure: 0.1 MPaG
Regeneration pressure: −90 kPaG
Temperature: 40° C.

In accordance with the above-described method for producing dry ice, 100 kg of dry ice was produced using the produced purified gas. Conditions used for producing dry ice are as follows. As a dehumidifying part, zeolite was used.

### (Conditions of Producing Dry Ice)

Liquefying pressure: 2 MPaG
Liquefying temperature: −20° C.

### Example 2

The same device as used in Example 1 was prepared as a first concentration device, and a membrane separation device was prepared as a second concentration device. The conditions of the first concentration device are the same as those in Example 1. The conditions of the second concentration device are as follows. A prepared target gas and equipment and conditions used for producing dry ice are the same as those in Example 1 (the same goes for Comparative Examples 1 and 2 below).

### (Conditions of Second Concentration Device)

Flow rate of intermediate gas: 60 NL/min
Pressure: 0.7 MPaG
Temperature 30° C.

### Comparative Example 1

The same device as used in Example 1 was prepared as a first concentration device, and a pressure swing adsorption device was prepared as a second concentration device. The conditions of the first concentration device are the same as those in Example 1. The conditions of the second concentration device are as follows. The second concentration device used activated alumina as a carbon dioxide gas adsorbent.

### (Conditions of Second Concentration Device)

Flow rate of intermediate gas: 60 NL/min
Adsorption pressure: 0.7 MPaG
Regeneration pressure: atmospheric pressure
Temperature: 40° C.

### Comparative Example 2

The same membrane separation device as used in Example 2 was prepared as a first concentration device, and the same second concentration device as used in Example 1 was prepared as a second concentration device. The conditions of the second concentration device are the same as those in Example 1. The conditions of the first concentration device are as follows. It should be noted that a liquefying pressure in the step of producing dry ice was 2.3 MPaG.

### (Conditions of First Concentration Device)

Flow rate of intermediate gas: 30 NL/min
Pressure: 0.5 MPaG
Temperature: 25° C.

### <Evaluations>

### (Concentration of Carbon Dioxide Gas)

In each of Examples and Comparative Examples, the concentration of carbon dioxide gas in an intermediate gas obtained by the first concentration device and the concentration of carbon dioxide gas in a purified gas obtained by the second concentration device were measured. The measurement was performed by gas chromatography (produced by SHIMADZU CORPORATION, model number: GC-2014AF). The results are shown in columns of “CO₂ concentration” in Table 1.

### (Evaluation of Amount of Emission of Carbon Dioxide Gas)

In each of Examples and Comparative Examples, the amount of emission of carbon dioxide gas was evaluated. This is an evaluation value calculated from energy consumed from the first concentration step to the dry ice production step and the amount of emission of carbon dioxide gas in terms of electric power. The evaluation of amount of emission is performed using the following formula (1).

$$Evaluation of amount of emission = electric power ( kW ) \times {CO}_{2} coefficient ( kg / kW ) / amount of {CO}_{2} recovered ( kg ) \qquad ( 1 )$$

In the above formula (1), the CO₂ coefficient is defined as 0.47. In each of Examples and Comparative Examples, the amount of dry ice recovered is 100 kg, and therefore the amount of CO₂ recovered in the above formula (1) is defined as 100 kg.

The results are shown in columns of “Evaluation of amount of emission” in Table 1. When smaller than 1, the value indicates that the amount of carbon dioxide gas recovered exceeds the amount of emission of carbon dioxide gas, and when larger than 1, the value indicates that the amount of emission of carbon dioxide gas exceeds the amount of carbon dioxide gas recovered. In Examples, when the evaluation value was closer to 1, the result of evaluation was graded as more excellent.

TABLE 1

| | CO₂ concentration | | Energy evaluation | |
|---|---|---|---|---|
| | Intermediate | Purified | Electric | Evaluation |
| | gas | gas | power | of amount |
| | (vol %) | (vol %) | (kW) | of emission |
| Example 1 | 70 | 98 | 437 | 2.1 |
| Example 2 | 70 | 99 | 488 | 2.3 |
| Comparative Example 1 | 70 | 88 | 1457 | 6.9 |
| Comparative Example 2 | 55 | 98 | 1362 | 6.4 |

### <Results>

As shown in Table 1, in Examples 1 and 2, a purified gas containing 98 vol % of carbon dioxide gas and a purified gas containing 99 vol % of carbon dioxide gas could respectively be obtained. Further, in Examples 1 and 2, the amounts of emission of carbon dioxide gas were respectively evaluated as 2.1 and 2.3 that were close to 1.

On the other hand, in Comparative Example 1, a purified gas containing 88 vol % of carbon dioxide gas could be obtained, which was, however, a result inferior to those of Examples. Further, the amount of emission of carbon dioxide gas was evaluated as 6.9 that was higher as compared to Examples.

In Comparative Example 2, a purified gas containing 98 vol % of carbon dioxide gas could be obtained, which was a result comparable to those of Examples. On the other hand, the amount of emission of carbon dioxide gas was evaluated as 6.4 that was higher as compared to Examples.

As can be seen from the above results, the evaluation value of amount of emission of carbon dioxide gas of Example 1 is the lowest and the result of evaluation is graded as excellent.

As has been described above, the use of the method for producing a purified gas and the apparatus for producing a purified gas described in the present disclosure makes it possible to extract a purified gas containing a high concentration of carbon dioxide gas while reducing energy consumption. Further, the use of the method for producing dry ice and the equipment for producing dry ice described in the present disclosure makes it possible also to produce dry ice from the purified gas. This makes it possible to reduce global greenhouse gas and contribute to some of actions for Sustainable Development Goals (SDGs) It should be noted that renewable energy may be used for electric power.

It should be noted that when carbon dioxide gas is directly turned into dry ice by removing moisture from a target gas and then cooling the target gas to a solidification temperature as in the case of a conventional technique, the above-described evaluation of amount of emission of carbon dioxide gas is estimated to be about 10.

The embodiments and the Examples disclosed herein are illustrative in all aspects and should be construed not to be restrictive. The scope of the present disclosure is defined not by the above description but by the claims, and all changes which come within the meaning and range of equivalency of the claims are therefore intended to be embraced therein.

### REFERENCE SIGNS LIST

1 First concentration device; 2 Second concentration device; 10, 10a, 10b First adsorption tower; 11 Target gas conduit pipe; 12 First blower; 13 First vacuum pump; 20, 20a, 20b Second adsorption tower; 21 Intermediate gas conduit pipe; 22 Second blower; 23 Second vacuum pump

1. A method for producing a purified gas containing carbon dioxide gas, comprising:
a first concentration step in which an intermediate gas having a higher concentration of carbon dioxide gas than a target gas is produced by vacuum regeneration pressure swing adsorption using a first adsorption tower that adsorbs carbon dioxide gas from the target gas containing carbon dioxide gas; and
a second concentration step in which the purified gas having an even higher concentration of carbon dioxide gas than the intermediate gas is produced by vacuum regeneration pressure swing adsorption using a second adsorption tower that adsorbs carbon dioxide gas from the intermediate gas or membrane separation.

2. The method for producing a purified gas according to claim 1, wherein the target gas has a carbon dioxide gas concentration of 3 vol % or more and 70 vol % or less.

3. The method for producing a purified gas according to claim 1, wherein the intermediate gas has a carbon dioxide gas concentration of 50 vol % or more and 80 vol % or less.

4. The method for producing a purified gas according to claim 1, wherein the purified gas has a carbon dioxide gas concentration of 95 vol % or more.

5. The method for producing a purified gas according to claim 1, wherein the first concentration step and the second concentration step do not have a purge step to discharge impurities in the first adsorption tower and the second adsorption tower.

6. The method for producing a purified gas according to claim 1, wherein two or more of the first adsorption towers and two or more of the second adsorption towers are used.

7. The method for producing a purified gas according to claim 1, wherein in the second concentration step, carbon dioxide gas is concentrated at a higher pressure than in the first concentration step.

8. A method for producing dry ice, comprising:
obtaining a purified gas by the method for producing a purified gas according to claim 1;
a liquefying step in which the purified gas is cooled to produce liquefied carbon dioxide; and
a dry ice production step in which the liquefied carbon dioxide is solidified to obtain dry ice.

9. The method for producing dry ice according to claim 8, comprising a dehumidifying step to remove moisture in the purified gas prior to the liquefying step.

10. The method for producing dry ice according to claim 8, wherein the dry ice production step includes a forming step to form dry ice.

11. An apparatus for producing a purified gas containing carbon dioxide gas, comprising:
a first concentration device that produces an intermediate gas having a higher concentration of carbon dioxide gas than a target gas, wherein the first concentration device includes a first adsorption tower that adsorbs carbon dioxide gas in the target gas containing carbon dioxide gas by vacuum regeneration pressure swing adsorption; and
a second concentration device that produces a purified gas having an even higher concentration of carbon dioxide gas than the intermediate gas, wherein the second concentration device includes a second adsorption tower that adsorbs carbon dioxide gas in the intermediate gas by vacuum regeneration pressure swing adsorption or a membrane separation device that selectively passes carbon dioxide gas in the intermediate gas.

12. The apparatus for producing a purified gas according to claim 11, comprising two or more of the first adsorption towers and two or more of the second adsorption towers.

13. Equipment for producing dry ice, comprising:
the apparatus for producing a purified gas according to claim 11;
a refrigerating machine that cools the purified gas to produce liquefied carbon dioxide; and
a dry ice production apparatus that solidifies the liquefied carbon dioxide to produce dry ice.

14. The equipment for producing dry ice according to claim 13, further comprising a dehumidifying part that removes moisture before liquefied carbon dioxide is produced.

15. The equipment for producing dry ice according to claim 13, wherein the dry ice production apparatus comprises a forming device that forms dry ice.
